(19) United States
(12) Patent Application Publication
(10) Pub. No.: US 2008/0263613 A1
(43) Pub. Date: Oct. 23, 2008

(54) Communication Framework and Connection Method for Providing a Remote Real-Time Audio and/or Video (AV) Signal

(76) Inventor: Yuan-Yuan Lin, Taipei City (TW)

Correspondence Address: THELEN REID BROWN RAYSMAN & STEINER LLP, P.O. BOX 640640, SAN JOSE, CA, 95164-0640, US

(21) Appl. No.: 12/034,638

(22) Filed: Feb. 20, 2008

(30) Foreign Application Priority Data
Apr. 19, 2007 (TW) 096113788

(51) Int. Cl. H04N 7/173

(52) U.S. Cl. 725/118

(57) ABSTRACT

A connection method for providing a remote real-time audio and/or video (AV) signal includes: when a connection request that corresponds to a selected AV terminal is received from a user terminal, determining whether the selected AV terminal belongs to an AV terminal group, which includes a plurality of AV terminals; if it is determined that the selected AV terminal belongs to the AV terminal group, establishing connections with the selected AV terminal and at least one other AV terminal in the AV terminal group, and forwarding the AV signal of the selected AV terminal to the user terminal; and in response to a switch command from the user terminal, forwarding the AV signal of another one of the AV terminals in the AV terminal group to the user terminal. A communication framework that performs the method is also disclosed.

### CROSS-REFERENCE TO RELATED APPLICATION

This application claims priority of Taiwanese application no. 096113788, filed on Apr. 19, 2007.

### BACKGROUND OF THE INVENTION

1. Field of the Invention

This invention relates to a connection method for providing a remote real-time audio and/or video (AV) signal through a third generation (3G) telecommunication network and the Internet, and to a communication framework that provides a remote real-time AV signal using the connection method.

2. Description of the Related Art

A conventional communication framework for providing audio and/or video (AV) signal includes a user terminal and an AV terminal. The user terminal, such as a packet or a third generation (3G) compliant user terminal, establishes a connection with and receives an AV signal of the AV terminal, such as an IP camera or a 3G-compliant camera, through a network, such as the Internet or a 3G telecommunication network.

The aforementioned conventional communication framework is disadvantageous in that, due to inherent delays in the network, each time the user terminal establishes the connection with the AV terminal to receive the AV signal thereof, the user terminal has to wait for at least ten seconds. Moreover, the conventional communication framework merely permits a one-to-one connection between a user terminal and an AV terminal. As such, only one user terminal can access an AV terminal at a time.

### SUMMARY OF THE INVENTION

Therefore, the object of the present invention is to provide a communication framework and method for providing a remote real-time audio and/or video (AV) signal.

According to one aspect of the present invention, a connection method for providing a remote real-time audio and/or video (AV) signal comprises:

A) when a connection request that corresponds to a selected AV terminal is received from a user terminal, enabling an AV platform to determine whether the selected AV terminal belongs to an AV terminal group, the AV terminal group including at least one other AV terminal, each of the selected AV terminal and said at least one other AV terminal providing an AV signal of a surrounding environment;

B) if it is determined in step A) that the selected AV terminal belongs to the AV terminal group,

enabling the AV platform to establishe a connection with the selected AV terminal and said at least one other AV terminal in the AV terminal group, and to forward the AV signal of the selected AV terminal to the user terminal, and

in response to a switch command from the user terminal, enabling the AV platform to forward the AV signal of another one of the AV terminals in the AV terminal group to the user terminal; and

C) if it is determined in step A) that the selected AV terminal does not belong to the AV terminal group, enabling the AV platform to establish a connection with the selected AV terminal and to forward the AV signal of the selected AV terminal to the user terminal.

According to another aspect of the present invention, a communication framework comprises an AV terminal group, an AV platform, and a user terminal. The AV terminal group includes a plurality of AV terminals, each of which generates a signal. The AV platform is connected to the AV terminals in the AV terminal group through a telecommunication network. The user terminal is connected to the AV platform through the telecommunication network. When the user terminal establishes a connection with the AV platform, the AV platform establishes simultaneous connections with at least two of the AV terminals in the AV terminal group.

According to yet another aspect of the present invention, a connection system for providing a remote real-time audio and/or video (AV) signal to at least one user terminal comprises a plurality of AV terminals and an AV platform. Each of the AV terminals provides an AV signal of a surrounding environment. The AV platform stores information pertinent to the AV terminals, includes an AV terminal group that includes at least a portion of said AV terminals, and is operable so as to establish connections with the user terminal and the AV terminals. The AV platform establishes connections with the AV terminals in the AV terminal group and forwards the AV signal of a selected AV terminal to the user terminal when the AV platform receives a connection request that contains the selected AV terminal from the user terminal and when the selected AV terminal belongs to the AV terminal group. The AV platform forwards the AV signal of another one of the AV terminals in the AV terminal group to the user terminal upon receipt of a switch command from the user terminal.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of the preferred embodiment of a communication framework for providing a remote real-time audio and/or video (AV) signal according to the present invention;

FIG. 2 is a schematic block diagram of an AV terminal of the preferred embodiment; and

FIG. 3 is a flowchart to illustrate the preferred embodiment of a connection method for providing a remote real-time AV signal using a communication framework according to the present invention.

### DETAILED DESCRIPTION OF THE PREFERRED EMBODIMENTS

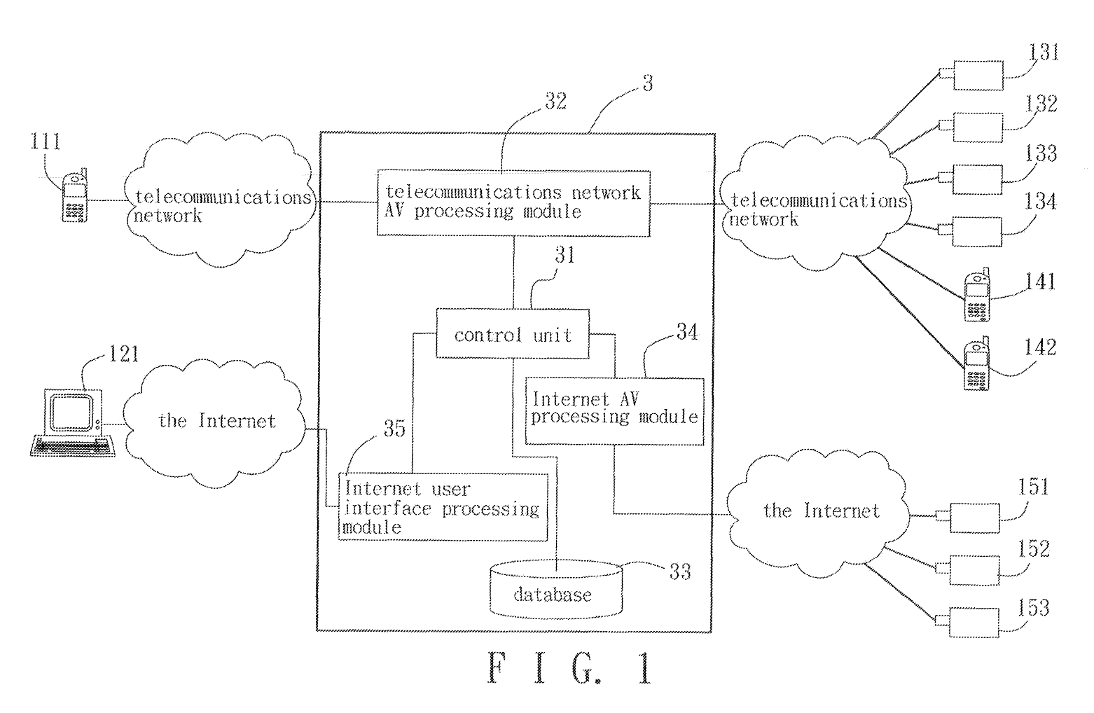

Referring to FIG. 1, the preferred embodiment of a communication framework according to this invention is shown to include a connection system and user terminals 111, 121.

The connection system provides the user terminals 111, 121 with a remote audio and/or video (AV) signal in real-time over a telecommunication network and the Internet, in a manner that will be described hereinafter.

In this embodiment, the telecommunication network is a third generation (3G) telecommunication network.

The connection system includes a plurality of AV terminals 131, 132, 133, 134, 141, 142, 151, 132, 153 and an AV platform 3.

Each of the AV terminals 131, 132, 133, 134 is a 3G-compliant camera, has an identification code, i.e., a phone number, and is connected to the telecommunication network.

Each of the AV terminals 141, 142 is a 3G-compliant mobile phone, has an identification code, i.e., a phone number, and is connected to the telecommunication network.

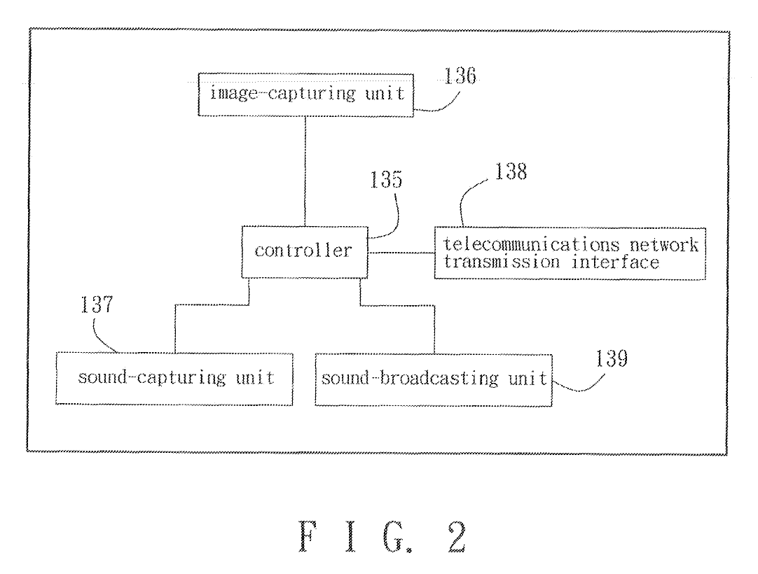

With further reference to FIG. 2, each of the AV terminals 131, 132, 133, 134, 141, 142 includes a controller 135, an image-capturing unit 136, a sound-capturing unit 137, a telecommunication network transmission interface 138, and a sound-broadcasting unit 139.

The controller 135 controls operation of the AV terminals 131, 132, 133, 134, 141, 142. The image-capturing unit 136 is connected to the controller 135, and is operable so as to capture images of a surrounding environment. The sound-capturing unit 137 is connected to the controller 135, and is operable so as to capture sounds of the surrounding environment. The controller 135 combines the images captured by the image-capturing unit 136, i.e., a video signal, the sounds captured by the sound-capturing unit 137, i.e., an audio signal, and/or a control signal into an AV signal. The telecommunication network transmission interface 138 is connected to the telecommunication network and the controller 135, and is operable so as to transmit the AV signal through the telecommunication network.

Each of the AV terminals 151, 152, 153 is an IP camera, has an identification code, i.e., an Internet protocol (IP) address, and is connected to the Internet.

Each of the AV terminals 151, 152, 153, like the AV terminals 131, 132, 133, 134, 141, 142, includes the controller 135, the image-capturing unit 136, the sound-capturing unit 137, the telecommunication network transmission interface 138, and the sound-broadcasting unit 139. The telecommunication network transmission interface 138 of each of the AV terminals 151, 152, 153, however, is connected to the Internet, instead of the telecommunication network, and is operable so as to transmit the AV signal through the Internet.

In an alternative embodiment, each of the AV terminals 131, 132, 133, 134, 141, 142, 151, 152, 153 may be dispensed with one of the image-capturing unit 136 and the sound-capturing unit 137.

The AV platform 3 is implemented as a computer server, and includes a control unit 31, a telecommunication network AV processing module 32, an Internet AV processing module 34, an Internet user interface processing module 35, and a database 33.

The control unit 31 controls operation of the AV platform 3, and is operable so as to establish connections with the user terminal 111 and each of the AV terminals 131, 132, 133, 134, 141, 142 through the telecommunication network via the telecommunication network AV processing module 32, with each of the AV terminals 151, 152, 153 through the Internet via the Internet AV processing module 34, and with the user terminal 121 through the Internet via the Internet user interface processing module 35.

The telecommunication network AV processing module 32 is connected to the telecommunication network and the control unit 31, and is operable so as to receive the AV signal of each of the AV terminals 131, 132, 133, 134, 141, 142 through the telecommunication network, and so as to forward the AV signal of one of the AV terminals 131, 132, 133, 134, 141, 142 to the user terminal 111 through the telecommunication network. The Internet user interface processing module 35 is connected to the Internet and the control unit 31, and is operable so as to forward the AV signal from the telecommunication network AV processing module 32 to the user terminal 121 through the Internet. In this embodiment, the AV signal is first separated into the audio and video signals and/or the control signal by the telecommunication network AV processing module 32, and the audio and video signals and/or the control signal are then processed accordingly, and are combined back into the AV signal by the control unit 31 prior to forwarding of the AV signal to the user terminals 111, 121.

The Internet AV processing module 34 is connected to the Internet and the control unit 31, and is operable so as to receive the AV signal of each of the AV terminals 151, 152, 153 through the Internet. The Internet user interface processing module 35 is further operable so as to transmit the AV signal from the Internet AV processing module 34 to the user terminal 121 through the Internet. The telecommunication network AV processing module 32 is further operable so as to transmit the AV signal from the Internet AV processing module 34 to the user terminal 111 through the telecommunication network. In this embodiment, the AV signal is first separated into the audio and video signals and/or the control signal by the Internet AV processing module 34, and the audio and video signals and/or the control signal are then processed accordingly, and are combined back into the AV signal by the control unit 31 prior to forwarding of the AV signal to the user terminals 111, 121.

The database 33 is connected to the control unit 31, and stores ah identification code, i.e., a phone number, of each of the AV terminals 131, 132, 133, 134, 141, 142, and an identification code, i.e., Internet protocol (IP) address, of each of the AV terminals 151, 152, 153.

In this embodiment, the database 33 further stores a first list, which includes the AV terminals 131, 132, 141, 151, specific to the user terminal 111, and a second list, which includes the AV terminals 131, 142, 151, specific to the user terminal 121, and an AV terminal group, which includes the AV terminals 131, 141, 151, created by the user terminal 111.

The first list and the AV terminal group are specific to the user terminal 111. That is, the AV terminals 131, 132, 141, 151 in the first list, and the AV terminals 131, 141, 151 in the AV terminal group are accessible by the user terminal 111, e.g., downloading of the AV signal of each of the AV terminals 131, 141, 151 by the user terminal 111 is permissible. Similarly, the second list is specific to the user terminal 121. That is, the AV terminals 131, 142, 151 in the second list are accessible by the user terminal 121.

It is noted that, the AV terminal group may be configured by the user terminal 111 to remove one or more of the AV terminals 131, 141, 151 therefrom, and to add the AV terminal 132 in the first list thereinto.

The AV terminal group may be further configured by the user terminal 111 to include a plurality of sub-groups. For example, the AV terminals 131, 141 may form a sub-group, and the AV terminal 151 may form another sub-group.

The AV terminal group may be further configured by the user terminal 111 to permit the user terminal 121 to access the AV terminals 131, 141, 151 therein.

The user terminal 121 may be operated to create a second AV terminal group specific thereto, which includes one or more of the AV terminals 131, 142, 151 in the second list.

The database 33 further stores a third list of the AV terminals 133, 134, 152, 153 that do not belong to the first and second lists. In this embodiment, the AV terminals 133, 134, 152, 153 in the third list are accessible by the user terminals 111, 121 to download the AV signal thereof.

It is noted that the AV terminal group may be further configured by the user terminal 111 to add one or more of the AV terminals 133, 134, 152, 153 in the third list thereinto.

The user terminal 111 is a 3G mobile phone, has an identification code, i.e., a phone number, is connected to the telecommunication network, stores the identification code of each of the AV terminals 131, 132, 133, 134, 141, 151, 152, 153, and is operable so as to receive the AV signal from the telecommunication network AV processing module 32 of the AV platform 3 through the telecommunication network and so as to transmit the AV signal, which includes audio and video signals and/or a control signal, through the telecommunication network.

The user terminal 121 is a packet electronic device, such as a personal computer, has an identification code, i.e., an IP address, is connected to the Internet, stores the identification code of each of the AV terminals 131, 133, 134, 142, 151, 152, 153, and is operable so as to receive the AV signal from the Internet user interface processing module 35 through the Internet and so as to transmit AV signal, which includes audio and video signals and/or a control signal, through the Internet.

The telecommunication network AV processing module 32 of the AV platform 3 is further operable so as to receive the AV signal of the user terminal 111 through the telecommunication network and so as to forward the AV signal received thereby to a selected one of the AV terminals 131, 141, 151 in the AV terminal group through the telecommunication network. In this embodiment, the AV signal is first separated into the audio and video signals and/or the control signal by the telecommunication network AV processing module 32, and the audio and video signals and/or the control signal are then processed based on the identification code of the user terminal 111 and the control signal of the AV signal, and are combined back into the AV signal by the control unit 31 prior to forwarding of the AV signal to the selected one of the AV terminals 131, 141, 151 in the AV terminal group.

The Internet user interface processing module 35 is further operable so as to receive the AV signal of the user terminal 121 through the Internet. The Internet AV processing module 34 is further operable so as to forward the AV signal from the Internet user interface processing module 35 to a selected one of the AV terminals in the second AV terminal group through the Internet. In this embodiment, the AV signal is first separated into the audio and video signals and/or the control signal by the Internet user interface processing module 35, and the audio and video signals and/or the control signal are then processed based on the identification code of the user terminal 121 and the control signal of the AV signal, and are combined back into the AV signal by the control unit 31 prior to forwarding of the AV signal to the selected one of the AV terminals in the second AV terminal group.

The telecommunication network transmission interface 138 of each of the AV terminals 131, 132, 133, 134, 141, 142 is further operable so as to receive the AV signal from the telecommunication network AV processing module 32 through the telecommunication network. The sound-broadcasting unit 139 of each of the AV terminals 131, 132, 133, 134, 141, 142 is operable so as to generate, i.e., broadcast, sounds corresponding to the audio signal of the AV signal from the telecommunication network transmission interface 138.

The telecommunication network transmission interface 133 of each of the AV terminals 151, 152, 153 is further operable so as to receive the AV signal from the Internet AV processing module 34 through the Internet. The sound-broadcasting unit 139 of each of the AV terminals 151, 152, 153 is operable so as to generate sounds corresponding to the audio signal of the AV signal from the telecommunication network transmission interface 138.

It is noted that the identification code of each of the user terminals 111, 121 may further include an account name and a password.

The database 33 further stores the identification code of each of the user terminals 111, 121.

The AV platform 3 has a plurality of identification codes, i.e., phone numbers and IP addresses.

Each of the user terminal 111 and the AV terminals 131, 132, 133, 134 further stores one of the phone numbers of the AV platform 3.

Each of the user terminal 121 and the AV terminals 151, 152, 153 further stores one of the IP addresses of the AV platform 3.

In this embodiment, each of the AV terminals 131, 132, 133, 134, 141, 142 and the user terminal 111 communicates wish the telecommunication network AV processing module 32 of the AV platform 3 over the telecommunication network through the 3G. 324M protocol or the wireless application protocol/real-time streaming protocol (WAP/RTSP). Moreover, each of the AV terminals 151, 152, 153 and the user terminal 121 communicates with the Internet AV processing module 34 or the Internet user interface processing module 35 of the AV platform 3 over the Internet through the session initiation protocol/real-time transport protocol (SIP/RTP) of RTSP. Further, each of the telecommunication network AV processing module 32, the Internet AV processing modules 34, and the Internet user interface processing module 35 communicates with the control unit 31 through the session initiation protocol/Internet protocol (SIP/IP).

In this embodiment, the database 33 further stores a plurality of phone numbers, and maps the IP address of each of the AV terminals 151, 152, 153 to a respective one of the phone numbers. As such, the user terminals 111, 121 stay simply store the phone numbers, instead of the IP addresses, of the AV terminals 151, 152, 153.

From the above description, the communication framework of this invention forwards the AV signal of a selected one of the AV terminals in an AV terminal group to a user terminal and simultaneously establishes connections with the other AV terminals in the AV terminal group. As such, the communication framework of this invention seamlessly provides AV signals over the telecommunication network and the Internet.

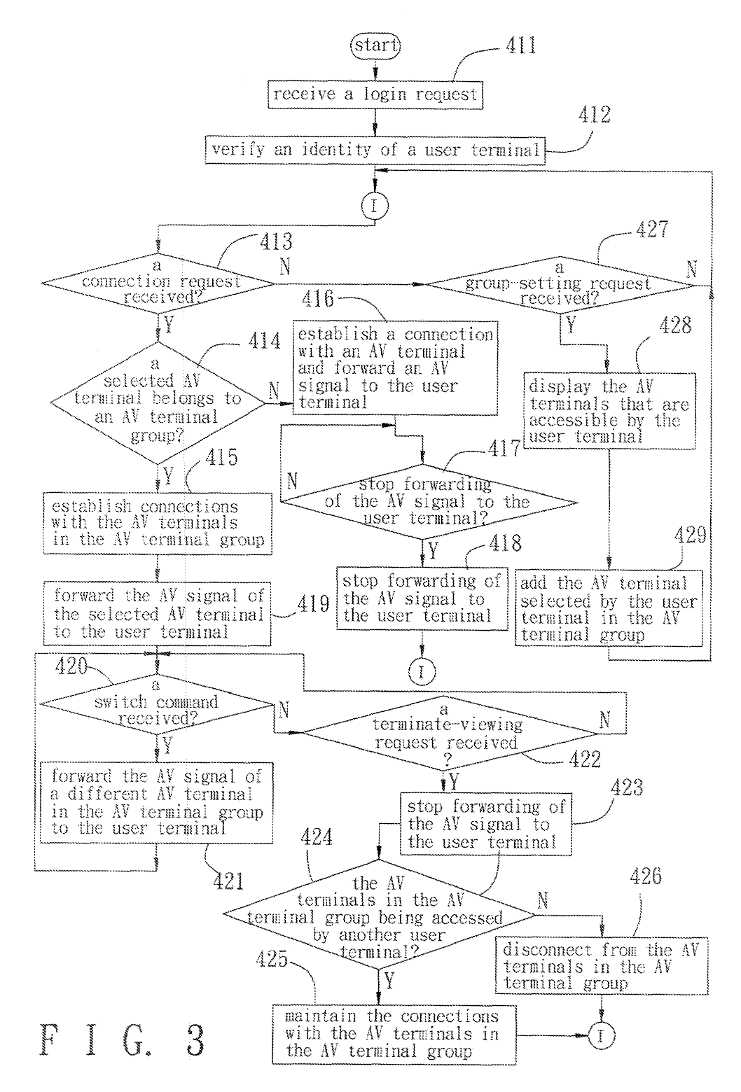

The preferred embodiment of a connection method for providing a remote real-time AV signal to be implemented using the aforementioned communication framework according to this invention will now be described with further reference to FIG. 3.

In step 411, the AV platform 3 receives a login request.

It is noted that, in this step, when the log in request is issued by the user terminal 111, the telecommunication network AV processing module 32 of the AV platform 3 receives the login request, and forwards the login request to the control unit 31 after converting the login request into a packet signal. On the other hand, when the login request is issued by the user terminal 121, the Internet user interface processing module 35 receives the login request, and forwards the login request to the control unit 31 after converting the login request into the packet signal.

In step 412, the AV platform 3 verifies an identity of a user. In particular, the control unit 31 compares the login request with user information in the database 33 to verify the identity of the user that issued the login request. At this time, the control unit 31 displays a user interface that includes a list. The list includes AV terminals in the database, which are accessible by the user, for selection by the user terminal 111 or 121. As an example, for the user terminal 111, the AV terminal list includes the AV terminals 131, 132, 133, 134, 141, 151, 152, 153. The AV terminals 131, 132, 141, 151 are privately accessible by the user terminal 111, while the AV terminals 152, 153 are publicly accessible. When the user terminal 111 or 121 selects one of the AV terminals, a connection request, which contains the identification code of the selected AV terminal, is issued to the AV platform 3. When the selected AV terminal is the AV terminal 131, the identification code contained in the connection request is a phone number. When the selected AV terminal is the AV terminal 151, the identification code contained in the connection request is a phone number that corresponds to an IP address.

In addition, when the user terminal 111 is a 3G mobile phone, the AV platform 3 may use the phone number of the user terminal 111 to verify the identify of the user terminal 111. As such, the AV platform 3 may be set so as to permit the user terminal 111 to access functionalities thereof without first issuing the login request. For example, the user terminal 111, when accessing the AV terminals 131, 132, 133, 134, 141, 142, 151, 152, 153, may simply issue a connection request that contains the identification code, i.e., phone number, of the selected AV terminal. The AV platform 3 may then determine whether the user terminal 111 can access the selected AV terminal based on the connection request received thereby. If the AV platform 3 determines that the user terminal 111 is not allowed to access the selected AV terminal, the connect ion request is ignored.

In step 413, it is determined whether the connection request is received. If it is determined that the connection request is received, the flow proceeds to step 414. Otherwise, the flow proceeds to step 427.

In step 414, the control unit 31 determines whether the selected AV terminal belongs to an AV terminal group. The AV terminal group is specific to the user terminal that issued the connection request. If it is determined that the selected AV terminal belongs to the AV terminal group, the flow proceeds to step 415. Otherwise, the flow proceeds to step 416.

In step 415, the control unit 31 establishes connections with the AV terminals in the AV terminal group. When the connection request is issued by the user terminal 111 and when the selected AV terminal is the AV terminal 131, since the AV terminal 131 belongs to the AV terminal group in the user information, the control unit 31 establishes connections with the AV terminals 131, 141, 151 in the AV terminal group through the telecommunication network AV processing module 32, and receives the AV signals of the AV terminals 131, 141, 151. Thereafter, the flow proceeds to step 419.

It is noted that, in this step, the control unit 31 may establish connections with only two of the AV terminals in the AV terminal group, one of which is the selected AV terminal and the other one of which is selected by the control unit 31.

In step 416, the control unit 31 establishes a connection with the selected AV terminal 132 through the telecommunication network AV processing module 32, receives the AV signal of the AV terminal 132, and forwards the AV signal of the AV terminal 132 to the user terminal 111.

In step 417, if it is determined that a terminate-viewing request is received from the user terminal 111, the flow proceeds to step 418. Otherwise, the flow loops in step 417 to continue forwarding the AV signal to the user terminal 111.

In step 418, the forwarding of the AV signal to the user terminal 111 is stopped, and connection to the selected AV terminal is disconnected after confirming that the selected AV terminal is not being accessed by another user terminal, e.g., the user terminal 121. Thereafter, the flow goes back to step 413.

In step 419, the control unit 31 forwards the AV signal of the selected AV terminal to the user terminal 111 after processing the AV signal of the selected AV terminal. For example, when the user terminal 111 selects the AV terminal 131, the control unit 31 forwards the AV signal of the AV terminal 131 to the user terminal 111 through an AV telephone. On the other hand, when the user terminal 121 selects the AV terminal 131, the control unit 31 forwards the AV signal to the user terminal 121 after converting the AV signal into a packet signal through the Internet user interface processing module 35. Thereafter, the user terminal 111 or 121 may simply issue a switch command in order to access the other AV terminals in the AV terminal group.

In step 420, the control unit 31 determines whether the switch command is received. If it is determined that the switch command is received, the flow proceeds to step 421. Otherwise, the flow proceeds to step 422.

In step 421, the control unit 31 forwards the AV signal of a different AV terminal (i.e., not the selected AV terminal) in the AV terminal group to the user terminal 111 or 121. Thereafter, the flow goes back to step 420.

It is noted that, in this step, when the user terminal 111 selects the AV terminal 131, and the AV terminals in the user information include the AV terminals 131, 141, 151, the control unit 31 forwards the AV signal of the AV terminal 141 or 151 received in step 415 to the user terminal 111. The control unit 31 may randomly or sequentially select the different AV terminal from the AV terminals in the AV terminal group. It is noted that, since the control unit 31 has established the connections with the AV terminals in the AV terminal group, the control unit 31, upon receipt of the switch command, can forward the AV signal to the user terminal without delay. As such, a real-time access of different AV terminals is achieved. In addition, if the control unit 31 has established connections with only two of the AV terminals in the AV terminal group, the control unit 31, upon receipt of the switch command, forwards the AV signal of a different AV terminal of the connected. AV terminals in the AV terminal group to the user terminal 111, and at the same time, establishes a connection with one of the disconnected AV terminals.

In step 422, the control unit 31 determines whether a terminate-viewing request is received. If it is determined that the terminate-viewing request is received, the flow proceeds to step 423. Otherwise, the flow goes back to step 420.

In step 423, the control unit 31 stops forwarding of the AV signal to the user terminal 111 or 121.

In step 424, if it is determined that the AV terminals in the AV terminal group are being accessed by another user terminal, the flow proceeds to step 425. Otherwise, the flow proceeds to step 426.

In step 425, the control unit 31 maintains the connections with the AV terminals in the AV terminal group. Thereafter, the flow goes back to step 413.

If is noted that, in this step, the control unit 31 may maintain the connections with the AV terminals in the AV terminal group that are being accessed by another user terminal, and may be disconnected from the AV terminals in the AV terminal group that are not being accessed.

In step 426, the control unit 31 disconnects from the AV terminals in the AV terminal group. Thereafter, the flow goes back to step 413.

In step 427, if it is determined that a group-setting request is received, the flow proceeds to step 428. Otherwise, the flow goes back to step 413.

In step 428, the control unit 31 displays the AV terminals, which are accessible by the user terminal, for selection by the user terminal. For example, when the group-setting request is issued by the user terminal 111, the AV terminals 131, 132, 133, 134, 141, 151, 152, 153 are displayed.

In step 429, the control unit 31 acids the AV terminal selected by the user terminal 111 or 121 in the AV terminal group. Thereafter, the flow goes back to step 413.

From the above description, the connection method of this invention permits the user terminal 111 or 121 to create an AV terminal group, which includes a plurality of AV terminals. When the user terminal 111 or 121 accesses one of the AV terminal s in the AV terminal group, the AV platform 3 establishes connections with the other AV terminals in the AV terminal group, and receives an AV signal of each of the AV terminals in the AV terminal group. As such, the user terminal 111 or 121 may access AV terminals in the AV terminal group in real time. Moreover, the AV platform 3 verifies an identity of the user terminal 111 or 121 before granting access to the AV terminals, thereby enhancing security. Further, the AV signal is first separated into different signals (i.e., an audio signal, a video signal, and a control signal) before being processed. In addition, the telecommunication network AV processing module 32, the Internet AV processing module 34, and the Internet user interface processing module 35 permit the user terminal 111 or 121 to conveniently access the AV terminals 131, 132, 133, 134, 141, 142, 151, 152, 153.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A connection method for providing a remote real-time audio and/or video (AV) signal, said connection method comprising:
A) when a connection request that corresponds to a selected AV terminal is received from a user terminal, enabling an AV platform to determine whether the selected AV terminal belongs to an AV terminal group, the AV terminal group including at least one other AV terminal, each of the selected AV terminal and said at least one other AV terminal providing an AV signal of a surrounding environment;
B) if it is determined in step A) that the selected AV terminal belongs to the AV terminal group,
enabling the AV platform to establish a connection with the selected AV terminal and said at least one other AV terminal in the AV terminal group, and to forward the AV signal of the selected AV terminal to the user terminal, and
in response to a switch command from the user terminal, enabling the AV platform to forward the AV signal of another one of the AV terminals in the AV terminal group to the user terminal; and
C) if it is determined in step A) that the selected AV terminal does not belong to the AV terminal group, enabling the AV platform to establish a connection with the selected AV terminal and to forward the AV signal of the selected AV terminal to the user terminal.

2. The connection method as claimed in claim 1, wherein, in step A), the AV terminal group, which corresponds to the user terminal, is selected after confirming an identity of the user terminal.

3. The connection method as claimed in claim 1, wherein each of the AV terminals has an identification code, and the connection request, in step A), includes the identification code of the selected AV terminal.

4. The connection method as claimed in claim 3, wherein at least one of the AV terminals is a mobile phone, the identification code of which is a phone number, and the connection request, in step A), is generated through dialing of the phone number of the selected AV terminal by the user terminal.

5. The connection method as claimed in claim 3, wherein at least one of the AV terminals is an IP camera, the identification code of which is an Internet protocol address that has a corresponding phone number.

6. The connection method as claimed in claim 1, further comprising:
D) when a group-setting request is received from the user terminal, enabling the AV platform to forward a plurality of AV terminals to the user terminal for selection, and to set a selected one of the AV terminals to belong to the AV terminal group.

7. The connection method as claimed in claim 6, wherein, in step D), the AV terminals forwarded to the user terminal correspond to the user terminal.

8. The connection method as claimed in claim 1, wherein said another one of the AV terminals in the AV terminal group is randomly selected in response to the switch command in step B).

9. The connection method as claimed in claim 1, wherein said another one of the AV terminals in the AV terminal group is sequentially selected in response to the switch command in step B).

10. The connection method as claimed in claim 1, wherein, in step B), the forwarding of the AV signal to the user terminal is stopped when a terminate-viewing request is received from the user terminal, and the connections with the AV terminals in the AV terminal group are disconnected when the AV terminals in the AV terminal group are not being used by another user terminal.

11. A communication framework, comprising:
an AV terminal group including a plurality of AV terminals, each of which generates a signal;
an AV platform connected to said AV terminals in said AV terminal group through a telecommunication network; and
a user terminal connected to said AV platform through said telecommunication network;
wherein, when said user terminal establishes a connection with said AV platform, said AV platform establishes simultaneous connections with at least two of said AV terminals in said AV terminal group.

12. The communication framework as claimed in claim 11, wherein one of said at least two of said AV terminals simultaneously connected to said AV platform is selected by said user terminal, and said AV platform forwards the signal generated by said selected AV terminal to said user terminal.

13. The communication framework as claimed in claim 12, wherein said AV platform includes
a telecommunication network AV processing module that is coupled to said AV terminals and said user terminal,
a control unit that is coupled to said telecommunication network AV processing module, and that receives and processes a signal from said telecommunication network AV processing module, and
a database that is coupled to said control unit.

14. The communication framework as claimed in claim 12, wherein the signal generated by one of said AV terminals includes at least one of a video signal and an audio signal, and the signal forwarded by said AV platform to said user terminal includes at least one of an audio signal, a video signal, and a control signal.

15. The communication framework as claimed in claim 13, wherein said AV platform further includes an Internet AV processing module and an Internet user interface processing module that are coupled to said control unit.

16. The communication framework as claimed in claim 15, wherein said AV terminal group further includes a plurality of AV terminals coupled to said Internet AV processing module through the Internet.

17. The communication framework as claimed in claim 15, wherein said user terminal is coupled to said Internet AV processing module of said AV platform through the internet.

18. The communication framework as claimed in claim 11, wherein each of said AV terminals includes an image-capturing unit for capturing an image of a surrounding environment, a sound-capturing unit for capturing a sound of the surrounding environment, and a sound-broadcasting unit for broadcasting an audio signal from said user terminal.

19. A connection system for providing a remote real-time audio and/or video (AV) signal to at least one user terminal, said connection system comprising:
a plurality of AV terminals, each of which provides an AV signal of a surrounding environment; and
an AV platform storing information pertinent to said AV terminals, including an AV terminal group that includes at least a portion of said AV terminals, and operable so as to establish connections with the user terminal and said AV terminals;
said AV platform establishing connections with said AV terminals in said AV terminal group and forwarding the AV signal of a selected AV terminal to the user terminal when said AV platform receives a connection request that corresponds to said selected AV terminal from the user terminal and when said selected AV terminal belongs to said AV terminal group;
said AV platform forwarding the AV signal of another one of said AV terminals in said AV terminal group so the user terminal upon receipt of a switch command from the user terminal.

20. The connection system as claimed in claim 19, wherein at least one of said AV terminals is one of a third generation (3G) camera and a 3G mobile phone, said AV platform including
a control unit that controls operations of said AV platform,
a telecommunication network AV processing module that is coupled to a telecommunication network, that receives an AV signal from one of said 3G camera and said 3G mobile phone, that separates the AV signal into an audio signal and a video signal, and that forwards the audio signal and the video signal to said control unit, and
a database that stores information pertinent to said AV terminals, and said AV terminal group.

21. The connection system as claimed in claim 20, wherein at least one of said AV terminals is an IP camera, said AV platform further including an Internet AV processing modulo that is coupled to the Internet, that receives an AV signal from said IP camera, that separates the AV signal into an audio signal and a video signal, and that forwards the audio signal and the video signal to said control unit.

22. The connection system as claimed in claim 21, wherein the user terminal is an electronic equipment that is operable so as to establish a connection with the Internet, said AV platform further including an Internet user interface module responsible for signal transmission between the electronic equipment and said AV platform.

23. The connection system as claimed in claim 21, wherein said AV terminal group in said database corresponds to the user terminal,
said control unit selecting said AV terminal group, which corresponds to the user terminal, to determine whether the selected AV terminal belongs to said AV terminal group after confirming an identity of the user terminal.

24. The connection system as claimed in claim 21, wherein said control unit provides said AV terminals to the user terminal for selection when said control unit receives a group-setting request from the user terminal, sets one of said AV terminals selected by the user terminal to belong to said AV terminal group, and stores said AV terminal group in said database.

25. The connection system as claimed in claim 19, wherein said AV platform selects said another one of the AV terminals in the AV terminal group in one of sequentially and randomly upon receipt of a switch command from the user terminal.
